(19) United States
(12) Patent Application Publication
(10) Pub. No.: US 2010/0138654 A1
(43) Pub. Date: Jun. 3, 2010

(54) SYSTEM AND METHOD FOR AUTHENTICATION BASED ON PARTICLE GUN EMISSIONS

(75) Inventors: Pierre Betouin, Boulogne (FR); Mathieu Ciet, Paris (FR); Augustin J. Farrugia, Cupertino, CA (US)

Correspondence Address: Apple Inc., 1000 Louisiana Street, Fifty-Third Floor, Houston, TX, 77002, US

(73) Assignee: Apple Inc., Cupertino, CA (US)

(21) Appl. No.: 12/326,064

(22) Filed: Dec. 1, 2008

(51) Int. Cl. H04L 9/32

(52) U.S. Cl. 713/168; 726/7

(57) ABSTRACT

A system, method and computer readable medium are disclosed for authentication. The method includes generating a challenge on a sender based on physical emission properties of a particle gun; transmitting the challenge from the sender to a receiver; receiving the challenge on the receiver; and verifying the authenticity of an entity, such as data, an object or a person, at the receiver by comparing the challenge with a value generated at the receiver. The process of generating the challenge and value is such that it is difficult to retrieve details of the input data based on the output data.

### BACKGROUND OF THE INVENTION

1. Field of the Invention

The present invention relates to Digital Rights Management (DRM) and more specifically to authentication or hashing functions.

2. Introduction

The field of DRM involves code protection, code obfuscation and various other software security mechanisms. Cryptography is one such way to protect information. Cryptography is the practice of hiding information; encryption is the process of converting intelligible information (plaintext) into unintelligible information (ciphertext); and decryption is the process of converting ciphertext back into plaintext. Authentication is a software security mechanism that establishes or confirms an entity as authentic, or true. Hashing is also often utilized in authentication. Hashing is the process of producing a value (typically fixed length called a hash or digest) based on the input and has three main properties: it is easy to calculate a hash or digest for any given data, it is extremely difficult to calculate an input with a given hash or digest, and it is extremely unlikely that two different messages will have the same hash or digest.

In all of these areas, namely encryption, decryption, authentication, hashing, etc., that are included in cryptography, there is a set of basic tools or functions that are widely used, for instance hash functions and derivation functions. Authentication systems often utilize functions to derive information. The process of derivating information from provided data is iterated numerous times to ensure that the final information cannot be used to get details about the initial information. Allowing initial information to be recovered from final information is a major flaw in cryptography systems since the objective of cryptographic systems is to protect the initial information.

Many authentication systems exist. Accordingly, what is needed in the art is an improved way to perform authentication, such that it is difficult to extract initial information from final information.

### SUMMARY

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Disclosed are systems, methods, and tangible computer readable-media for authentication based on physical particle gun emissions. The method includes generating a first value on a sender based on physical emission properties of a particle gun; transmitting the first value from the sender to a receiver; receiving the first value on the receiver; and verifying the authenticity of an entity at the receiver by comparing the first value with a second value generated at the receiver. Generating the first and second values is based at least in part on input data that provides physical emission properties of the particle gun including at least one of initial speed, electromagnetic fields, mass, electronic charge and time. The method of authenticating based on physical particle gun emissions makes it difficult to recover initial input from output values.

In another aspect, the method of authentication includes generating a challenge on a sender based on physical emission properties of a particle gun and a secret value, transmitting the challenge from the sender to a receiver, receiving the challenge on the receiver and verifying authenticity of an entity at the receiver by comparing the challenge with a value generated at the receiver.

In yet another aspect, the method of authentication includes generating a first challenge value on a sender, transmitting the first challenge value from the sender to a receiver, receiving the first challenge value on the receiver, generating a second challenge value at the receiver and computing a receiver response based on the first challenge value, the second challenge value and a secret. The computation of the receiver response can be based on physical emission properties of a particle gun. The method further includes transmitting the receiver response to the sender and verifying authenticity of an entity at the sender by comparing an expected value of the receiver response with a calculated value based on the first challenge value, the second challenge value, a secret and being based on the physical emission properties of the particle gun.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 illustrates an example system embodiment;

FIG. 2 illustrates an example particle gun and conductive plates;

FIG. 3 illustrates an example particle gun rotation;

FIG. 4 illustrates example particle gun input and output;

FIG. 5 illustrates authentication based on particle gun physical theory;

FIG. 6 illustrates sender-based authentication; and

FIG. 7 illustrates receiver-based authentication.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

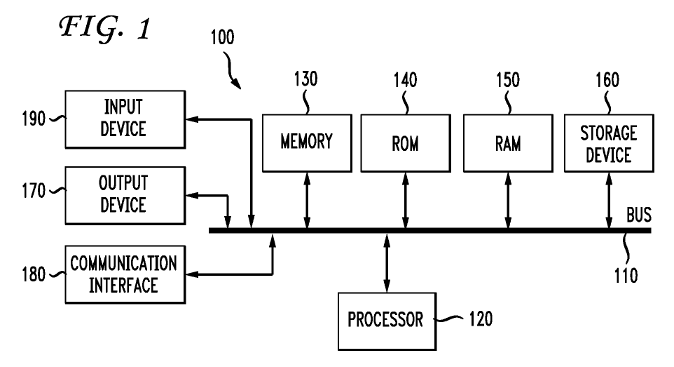

With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. A processing unit 120 can include a general purpose CPU controlled by software as well as a special-purpose processor. A processing unit includes any general purpose CPU and a module configured to control the CPU as well as a special-purpose processor where software is effectively incorporated into the actual processor design. A processing unit may essentially be a completely self-contained computing system, containing multiple cores or CPUs, a bus, memory controller, cache, etc. A multi-core processing unit may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software and hardware, such as a processor, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

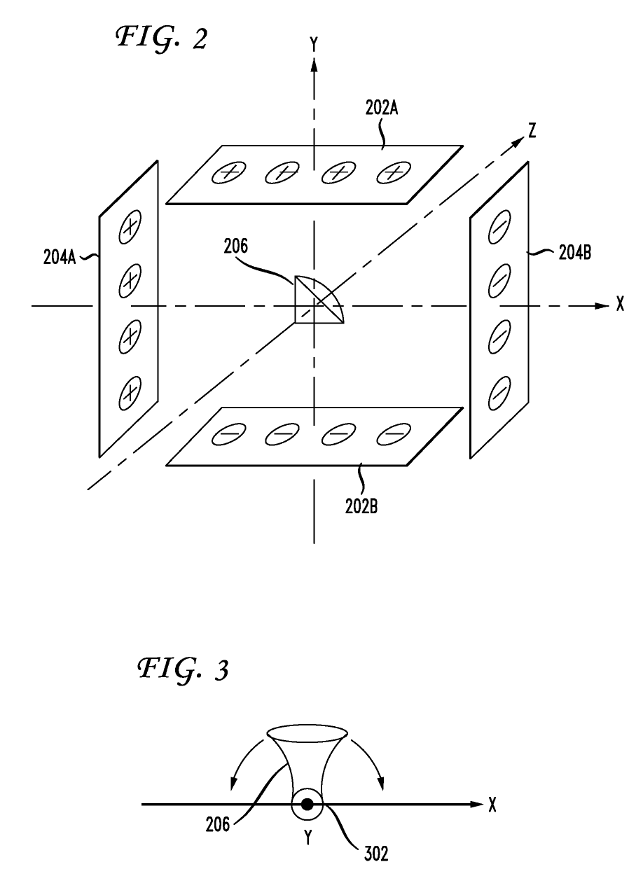

Having discussed the basic hardware components the disclosure now turns to other principles. The features of the present disclosure relates to utilizing properties of particle gun emissions. FIG. 2 illustrates an example particle gun and conductive plates. In the illustration, two separate, independent and uniform electromagnetic fields are generated by the pairs of conductive plates (202A, 202B and 204A, 204B). The particle gun 206 is located at the center of the x, y and z axis. A method of authentication based on particle gun physical theory is presented. The principle is to consider the inputs that give the physical properties of the event: time, mass, initial velocity, electromagnetic fields intensity, and orientation of the particles when they leave the gun. These properties govern the trajectory of the emitted particles as they pass through the electro magnetic fields created by the conductive plates.

FIG. 3 illustrates an example particle gun 302 rotation. The particle gun can be represented on a “kneecap” which allow a limited rotation over the axis x and y (from −90 degrees to 90 degrees). The particles are released in the direction of the z axis.

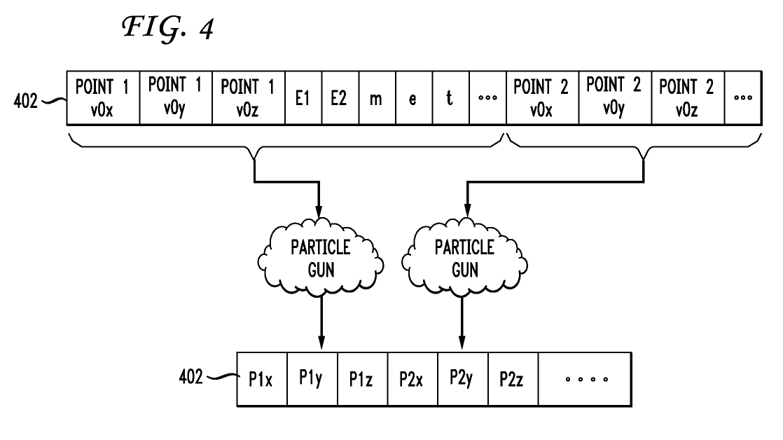

FIG. 4 illustrates an example particle gun input and output. The inputs to the particle gun are the initial speed vectors (v0x, v0y, v0z) in the Cartesian representation (3-D), electromagnetic fields E1 and E2, mass m, electronic charge q and time duration t of the capture for each particle 402. The initial speed vector v0z is independent of E1 and E2 and is constant. The electromagnetic fields E1 and E2, particle mass m, electronic charge q and time duration of the capture t change for each particle. The particle gun output is a sequence of three-dimensional (3-D) points that are independent and represented as one byte. In one embodiment, each output point is represented by three bytes 404 (one byte each for x, y and z values) and all axis are modulo-256. Modulo-256 simply means reducing the x, y and z values by setting them equal to the remainder of the value divided by 256. For instance, if the value of x is 257 before the modulo operation is performed, the result would be 1 after the modulo-256 operation is performed since the remainder of dividing 257 by 256 is 1. The one byte representation and axis modulo are exemplary, the particle gun output could be represented using 32-bit words for example and the axis modulo would be 2̂32. The actual values should not be limiting.

The challenge and the secret discussed below can both be derived from the point generation shown in FIG. 4. For instance, if the challenge needs to be 9-Byte long, and if 3-D points are considered as shown in FIG. 4, then the system would perform 3 particle launches in order to generate the 9 needed bytes. Then, the system will perform the same operation to generate an equivalent secret (which can be done on both sides).

The particle gun output length is a function of the number of shots made by the particle gun. The number of output points needed directly impacts the required length of the input stream. When the input stream is not long enough, an optional expansion function is used to expand the input to the desired length. The function must be deterministic and reproducible. The function could be either a digest function. A digest function or hash function is a function that produces a digest or hash value from the input. The expansion function does not have to be a digest function, several other expansion functions are possible. For example, the disclosures of U.S patent application Ser. No. 12/255,539 (P6865), Ser. No. 12/263,293 (P6952) and Ser. No. 12/263,071 (P7092) could be used to expand the input stream. Each of these applications is incorporated herein by reference. Simply expanding the input using an expansion function and concatenating the results with the original input could achieve the desired length of the input stream or this process could be repeated until the desired input length is reached.

The particle gun output is computed by utilizing the input values that represent variables in the particle gun principle (initial vector v0, electromagnetic fields E1 and E2, mass m, and capture time t). The same process is iterated for each set of output coordinates. The output coordinates (x, y, z in the Cartesian representation) for a set of input values are computed as follows:

x=v0x*t+[(q*E1)/(2*m)]*t̂2

y=v0y*t+[(q*E2)/(2*m)]*t̂2

z=v0z*t

wherein the “*” denotes multiplication and “̂” denotes the power operator. The electromagnetic force involved in the particle gun theory is F=q*E=m*a, wherein F is the electromagnetic force, q is the electronic charge of a particle, m is mass, a is acceleration and the variables F, E and a are vectors. The speed depends on the acceleration and is v=a*t+v0 wherein v is the speed, a is acceleration, t is time, v0 is the initial speed and the variables v, a and v0 are vectors.

The set of particle gun output coordinates is x, y and z in the Cartesian coordinate system. The Cartesian coordinate system uses three numbers for representing distances. Representing the output in the Cartesian coordinate system is exemplary and should not be limiting; other coordinate systems are possible. In fact, having different ways to implement the same process or represent the same data can be beneficial since it would make the task of reverse engineering the process more difficult. The reverse engineering would be more difficult, thus slowing down the attacker and keeping the process secure for a longer period of time.

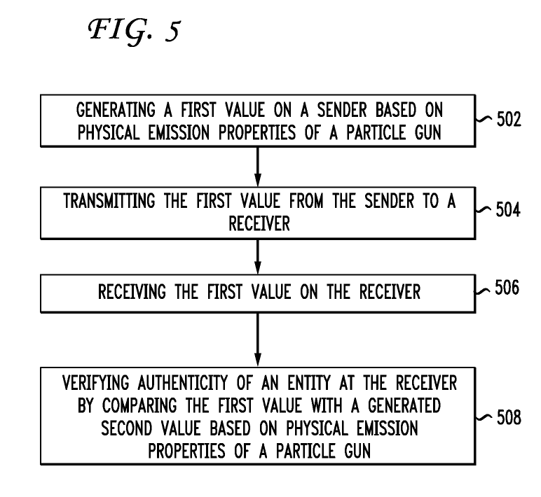

FIG. 5 illustrates authentication utilizing particle gun physical theory. The method of authentication is discussed in terms of a system performing the method. The system generates a first value on a sender which may or may not be based on physical properties of a particle gun (502). This first value represents a unique challenge value sent to the receiver. The system then transmits the first value from the sender to a receiver (504). The receiver receives the first value (506) and verifies authenticity of an entity by comparing the first value with a generated second value (508), wherein an entity is one of data, object or person. The second value is a unique challenge value generated at the receiver. A receiver response can also be generated which represents a hash or other function utilizing the first value, the second value and a secret value. The hash or other function can be based on the physical emission properties of a particle gun as set forth herein. The receiver can then send the receiver response and the second value to the sender. At this stage, the sender calculates the expected value of the receiver response (utilizing the physical emission properties) and ensures that receiver responded correctly. Generating the values is based at least in part on input data that provides physical emission properties of the particle gun including at least one of initial speed, electromagnetic fields, mass, electronic charge and time.

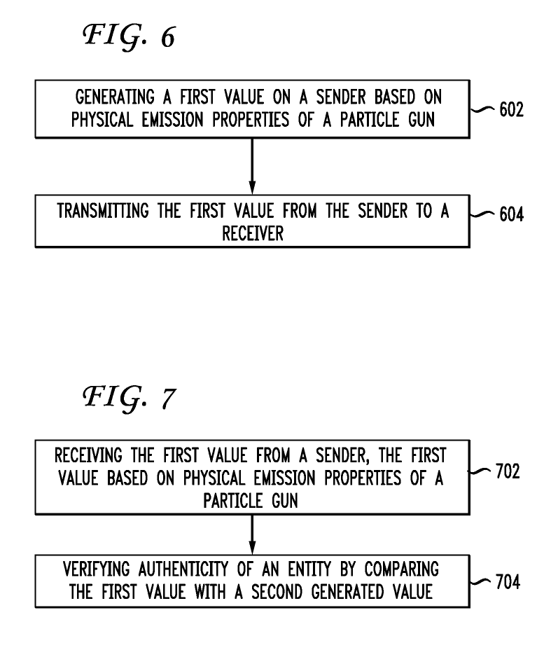

FIG. 6 illustrates the authentication process on a sender. The system generates a first value on a sender based physical emission properties of a particle gun (602). The system transmits the first value (or unique challenge) to a receiver (604). FIG. 7 illustrates the authentication process on a receiver. The system receives a first value from a sender (702). The first value can be based at least in part on the physical emission properties of a particle gun or selected in any manner. The system verifies the authenticity of an entity by comparing the first value with a second generated value (704), wherein an entity is one of data, an object or a person. For example, the object may be a portable device or desktop computer that requires authentication. A person may need to be authenticated to gain access to a computer or a building. The second value is based at least in part on the physical emission properties of a particle gun. The second generated value is a unique challenge generated at the receiver. The receiver may also compute a receiver response which is a hashing or other function of the second value, the first value and a secret. The hashing or other function can be based on the particle emission properties of a particle gun as disclosed herein. The receiver response and second value are transmitted to the sender, which calculates the expected value of the receiver response to determine whether it is correct.

In one aspect, the method of authentication includes generating a first challenge value or challenge on a sender, transmitting the first challenge value from the sender to a receiver, receiving the first challenge value on the receiver, generating a second challenge value at the receiver, computing a receiver response based on the first challenge value, the second challenge value and a secret wherein the computing of the receiver response being based on physical emission properties of a particle gun. The method further includes transmitting the receiver response to the sender and verifying authenticity of an entity at the sender by comparing an expected value of the receiver response with a calculated value based on the first challenge value, the second challenge value, a secret and being based on the physical emission properties of the particle gun.

The above describes a single authentication sequence but it can also involve mutual authentication in which the sender next computes a sender response which is a hash or other function of the sender challenge or first value, the second value and the secret. The sender then sends a sender response to the receiver, which calculates an expected value of the sender response and insures that the sender responded appropriately. The hash or other function described above could represent the particle gun emission.

The secret preferably comes from the particle gun process. The challenge can be randomly generated or generated from some other method.

The overall complexity of the authentication system is defined as the complexity to retrieve information from initial data considering the output. For example, if all variables are represented using one byte (this is non-restrictive, other data sizes are possible) each variable has a range of 256 values. Since the number of inputs of the particle gun is eight variables, then the overall complexity is: (2̂8)̂8=2̂64 wherein “̂” denotes the power operator. For the authentication system disclosed, the complexity to retrieve information from initial data considering the output is 2̂64, thus the complexity is also based on the length of the input data. Complexity may also be directly linked to the size of the input variables.

Embodiments within the scope of the present invention can also include tangible or intangible computer-readable media for carrying or having computer-executable instructions or data structures stored thereon. Such tangible computer-readable media can be any available media that can be accessed by a general purpose or special purpose computer, including the functional design of any special purpose processor as discussed above. By way of example, and not limitation, such tangible computer-readable media can comprise RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium or intangible computer-readable media when the media is wireless or a signal per se. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, data structures, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the invention. For example, the principles herein may be applied to derivating a value based on other physical properties other than particle gun emissions. For example, Newtonian properties associated with trajectory, distance and speed of a rifle or cannon could also be used. Other physical applications are contemplated as well. Those skilled in the art will readily recognize various modifications and changes that may be made to the present invention without following the example embodiments and applications illustrated and described herein, and without departing from the true spirit and scope of the present invention.

We claim:

1. A method of authentication, the method comprising:
generating a first challenge value on a sender;
transmitting the first challenge value from the sender to a receiver;
receiving the first challenge value on the receiver;
generating a second challenge value at the receiver;
computing a receiver response based on the first challenge value, the second challenge value and a secret, the computing of the receiver response being based on physical emission properties of a particle gun;
transmitting the receiver response to the sender; and
verifying authenticity of an entity at the sender by comparing an expected value of the receiver response with a calculated value based on the first challenge value, the second challenge value, a secret and being based on the physical emission properties of the particle gun.

2. The method of claim 1, wherein the physical emission properties include at least one of initial speed, electromagnetic fields, mass, electronic charge and time.

3. The method of claim 2, wherein the initial speed is represented by a vector (v0x, v0y, v0z), wherein v0z is constant and the electromagnetic fields E1 and E2, mass m, electromagnetic charge q, and time duration t change for each particle released from the particle gun, wherein each released particle relates to the input data.

4. The method of claim 1, wherein an entity is one of data, an object or a person.

5. The method of claim 2, wherein a set of coordinates x, y and z are computed as follows:
x=v0x*t+[(q*E1)/(2*m)]*t̂2
y=v0y*t+[(q*E2)/(2*m)]*t̂2
z=v0z*t
wherein v0x, v0y and v0z represent the initial speed vector in the Cartesian representation, E1 and E2 are electromagnetic fields, m is the initial mass, q is a charged particle and t is a capture time.

6. The method of claim 4, wherein a length of the output is a function of a number of shots made by the particle gun and an expansion function is utilized to expand the input data depending on the length of the output.

7. A method of verifying authenticity of an entity, the method comprising:
generating a first challenge value on a sender;
transmitting the first challenge value from the sender to a receiver, wherein the first challenge value is configured to enable the receiver to verify authenticity of an entity by comparing the first challenge value to a second challenge value generated at the receiver.

8. The method of claim 7, wherein generating the second challenge value is based at least in part on input data that provides physical emission properties of the particle gun including at least one of initial speed, electromagnetic fields, mass, electronic charge and time.

9. The method of claim 8, wherein the initial speed is represented by a vector (v0x, v0y, v0z in the Cartesian representation), wherein v0z is constant and the electromagnetic fields E1 and E2, mass m, electromagnetic charge q, and time duration t change for each particle released from the particle gun.

10. The method of claim 7, wherein the entity is one of data, an object or a person.

11. The method of claim 8, wherein a set of coordinates x, y and z are computed as follows:
x=v0x*t+[(q*E1)/(2*m)]*t̂2
y=v0y*t+[(q*E2)/(2*m)]*t̂2
z=v0z*t
wherein v0x, v0y and v0z represent the initial speed vector in the Cartesian representation, E1 and E2 are electromagnetic fields, m is the initial mass, q is a charged particle and t is a capture time.

12. The method of claim 10, wherein a length of the output is a function of a number of shots made by the particle gun and an expansion function is utilized to expand the input data depending on the length of the output.

13. A method of authentication, the method comprising:
receiving first challenge value from a sender, the first challenge value generated based at least in part on physical emission properties of a particle gun; and
verifying authenticity of an entity by comparing the first challenge value with a second generated challenge value.

14. The method of claim 13, wherein generating the second challenge value is based at least in part on input data that provides physical emission properties of the particle gun including at least one of initial speed and direction represented as (v0x, v0y,v0z) in the Cartesian representation, electromagnetic fields, mass, electronic charge and capture time.

15. The method of claim 14, wherein the initial speed is represented by a vector (v0x, v0y, v0z) in the Cartesian representation, wherein v0z is constant and the electromagnetic fields E1 and E2, mass m, electromagnetic charge q, and time duration t change for each particle released from the particle gun.

16. The method of claim 13, wherein the entity is one of data, an object or a person.

17. The method of claim 14, wherein a set of coordinates x, y and z are computed as follows:
x=v0x*t+[(q*E1)/(2*m)]*t̂2
y=v0y*t+[(q*E2)/(2*m)]*t̂2
z=v0z*t
wherein v0x, v0y and v0z represent the initial speed vector in the Cartesian representation, E1 and E2 are electromagnetic fields, m is the initial mass, q is a charged particle and t is a capture time.

18. The method of claim 16, wherein a length of the output is a function of a number of shots made by the particle gun and an expansion function is utilized to expand the input data depending on the length of the output.

19. The method of claim 13, wherein the entity is one of data, an object or a person.

20. A method of authentication, the method comprising:
generating a challenge on a sender based on physical emission properties of a particle gun and a secret value;
transmitting the challenge from the sender to a receiver;
receiving the challenge on the receiver; and
verifying authenticity of an entity at the receiver by comparing the challenge with a value generated at the receiver.
